(19) United States
(12) Patent Application Publication
(10) Pub. No.: US 2009/0286479 A1
(43) Pub. Date: Nov. 19, 2009

(54) METHOD AND SYSTEM FOR SENSORY PAIRING FOR A PORTABLE COMMUNICATION DEVICE

(75) Inventors: Johan Thoresson, Goteborg (SE); Ola Thorn, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/121,864

(22) Filed: May 16, 2008

(51) Int. Cl. H04B 7/155

(52) U.S. Cl. 455/41.3

(57) ABSTRACT

A wireless device (e.g., a mobile telephone) and method of paring wireless devices by positioning a first wireless device within an operable distance from a second wireless device facing each other for a predetermined time period. The wireless devices have detectors and electromagnetic sources. Electromagnetic radiation in a predefined pattern is detected the detector of the first wireless device, wherein the electromagnetic radiation was transmitted from the second electromagnetic radiation source. The detected is processed to establish a wireless communication link (e.g., GSM, CDMA, WCDMA, MBMS, WiFi, WiMax, DVB-H, ISDB-T, Bluetooth, infrared, etc.) between the first wireless device and the second wireless device. Upon establishing the communication link information (e.g., files, multimedia, images, etc.) rendered on one device may be transferred through the communication to the other device.

### TECHNICAL FIELD OF THE INVENTION

The present invention relates generally to electronic equipment, such as electronic equipment for engaging in voice communications and other communications. More particularly, the invention relates to a method and system for a plurality of electronic equipment to pair and/or otherwise establish a wireless communication link with each other.

### DESCRIPTION OF THE RELATED ART

Mobile and/or wireless electronic devices are becoming increasingly popular. For example, digital cameras, mobile telephones and portable media players are now in wide-spread use. In addition, the features associated with certain types of electronic devices have become increasingly diverse. To name a few examples, many electronic devices have cameras, text messaging capability, Internet browsing functionality, electronic mail capability, video playback capability, audio playback capability, image display capability and hands-free headset interfaces.

It is often desirable to have wireless devices communicate with each other. Generally, prior to such wireless communication, the devices must be paired with each other.

### SUMMARY

Accordingly, there is a need in the art for a device and method for automatically pairing wireless communication devices without requiring a user to enter information (e.g., a code).

One aspect of the present invention relates to a method for pairing wireless devices, the method including: positioning a first wireless device having a first detector and a first electromagnetic source on a first surface within an operable distance from a second wireless device having a second detector and a second electromagnetic source on a second surface, wherein the first surface and the second surface are oriented facing each other for a predetermined time period; detecting electromagnetic radiation in a predefined pattern at the first detector, wherein the electromagnetic radiation was transmitted from the second electromagnetic radiation source; processing the detected electromagnetic radiation to establish a wireless communication link between the first wireless device and the second wireless device based at least in part on the first wireless device and the second wireless device facing each other for the predetermined time period within the operable distance; and establishing the wireless communication link between the first wireless device and the second wireless device.

Another aspect of the invention relates to transmitting electromagnetic radiation in the predefined pattern from the first electromagnetic source for receipt by the second detector in response to detecting the electromagnetic radiation transmitted by the second electromagnetic radiation source.

Another aspect of the invention relates to the step of transmitting electromagnetic radiation in the predefined pattern from the first electromagnetic source to the second detector includes displaying the predefined pattern on a display associated with the first wireless device.

Another aspect of the invention relates to the predefined pattern being periodically displayed on the display for a duration that is not perceptible to an associated user of the first wireless device and/or the second wireless device.

Another aspect of the invention relates to the first detector being an optical sensor for detecting the response transmitted from the second wireless device.

Another aspect of the invention relates to the optical sensor being a video telephony camera.

Another aspect of the invention relates to the video telephony camera periodically acquires images associated with the second wireless device.

Another aspect of the invention relates to the first electromagnetic source is a light emitting diode that transmits electromagnetic radiation in the predefined pattern.

Another aspect of the invention relates to the detected electromagnetic radiation is generated by displaying the predefined pattern on a display associated with the second wireless device.

Another aspect of the invention relates to the step of processing the detected electromagnetic radiation to establish a wireless communication link between the first wireless device and the second wireless device includes determining whether the detected electromagnetic radiation is valid by comparing the detected electromagnetic radiation to one or more authorized responses stored in a memory of the first wireless device.

Another aspect of the invention relates to including detecting the predefined pattern of electromagnetic radiation at the second detector prior to transmitting the predefined pattern to the first wireless device.

Another aspect of the invention relates to the communication link being a cellular telephony communication link.

Another aspect of the invention relates to the communication link being a Bluetooth compatible communication link.

Another aspect of the invention relates to further including automatically transferring a file rendered on the first wireless device to the second wireless device upon establishing the wireless communication link.

One aspect of the invention relates to a wireless communication device including: a source of electromagnetic radiation and a sensor located on a surface of a housing of a wireless communication device; and a processor coupled to the source of electromagnetic radiation and the sensor, wherein when the sensor detects an associated wireless device is facing the wireless communication device and is positioned within an operable distance for a predefined period of time, the processor is configured to: detect electromagnetic radiation at the sensor, wherein the source of the electromagnetic radiation is an associated wireless device and output electromagnetic radiation in a predefined pattern; and process the detected electromagnetic radiation to establish a wireless communication link between the device and the associated wireless device based at least in part on the device and the associated wireless device facing each other for the predetermined period of time within the operable distance.

Another aspect of the invention relates to the sensor being an optical sensor.

Another aspect of the invention relates to the optical sensor being a video telephony camera.

Another aspect of the invention relates to the source of electromagnetic radiation being a display.

Another aspect of the invention relates to the source of electromagnetic radiation is a light emitting diode.

Another aspect of the invention relates to the device comprising a portable communication device.

Another aspect of the invention relates to the communication link being a Bluetooth compatible communication link.

Another aspect of the invention relates to the communication link being a cellular telephony communication link.

Another aspect of the invention relates to including a memory coupled to the processor, wherein the memory stores one or more authorized electromagnetic radiation predefined patterns for comparison by the processor with the detected electromagnetic radiation to determine whether the detected electromagnetic radiation is one or more authorized electromagnetic radiation predefined patterns.

One aspect of the invention relates to a wireless communication device including: a source of electromagnetic radiation and a sensor located on a surface of a housing of a wireless communication device; and a processor coupled to the source of electromagnetic radiation and the sensor, wherein when the sensor detects an associated wireless device is facing the wireless communication device and is positioned within an operable distance for a predefined period of time, the processor is configured to: transmit electromagnetic radiation in a predefined pattern from a source to an associated wireless device having a detector for detecting the predefined pattern of electromagnetic radiation; and establish a wireless communication link between the wireless device and the associated based on the wireless communication device facing the associated wireless device for the predefined period and for the predefined period of time.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments. It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIGS. 1-4 are exemplary schematic views of a mobile telephone as exemplary electronic equipment in accordance with an embodiment of the present invention.

FIG. 5 is another exemplary schematic view of a mobile telephone as an exemplary electronic equipment in accordance with an embodiment of the present invention.

FIG. 6 is a schematic block diagram of a electronic equipment in accordance with aspects of the present invention.

FIG. 7 is a flow chart of an exemplary wireless pairing method in accordance with the present invention.

### DETAILED DESCRIPTION OF EMBODIMENTS

The present invention will now be described with reference to the drawings, wherein like reference numerals are used to refer to like elements throughout. It will be understood that the figures are not necessarily to scale.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication devices or the like.

In the present application, the invention is described primarily in the context of a mobile telephone. However, it will be appreciated that the invention is not intended to be limited to a mobile telephone and can be any type of appropriate electronic equipment.

Before describing in detail embodiments that are in accordance with aspect of the present disclosure, it should be observed that the embodiments reside primarily in combinations of method steps and apparatus components related to preparing mobile communication devices for pairing with each other through a wireless communication link (e.g., GSM, CDMA, WCDMA, MBMS, WiFi, WiMax, DVB-H, ISDB-T, Bluetooth, infrared, etc.). Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, relational terms such as first and second, top and bottom, and the like may be used solely to distinguish one entity or action from another entity or action without necessarily requiring or implying any actual such relationship or order between such entities or actions.

Aspects of the present invention relate to pairing wireless devices. As used herein the terms “pairing” or “paired” means when two wireless devices agree to communicate with one another. Once the devices are paired, the two devices join what may be referred to as a trusted pair. When one device recognizes another device in an established trusted pair, each device automatically accepts communication, bypassing the discovery and authentication process that normally happen during wireless interactions (e.g., Bluetooth communications).

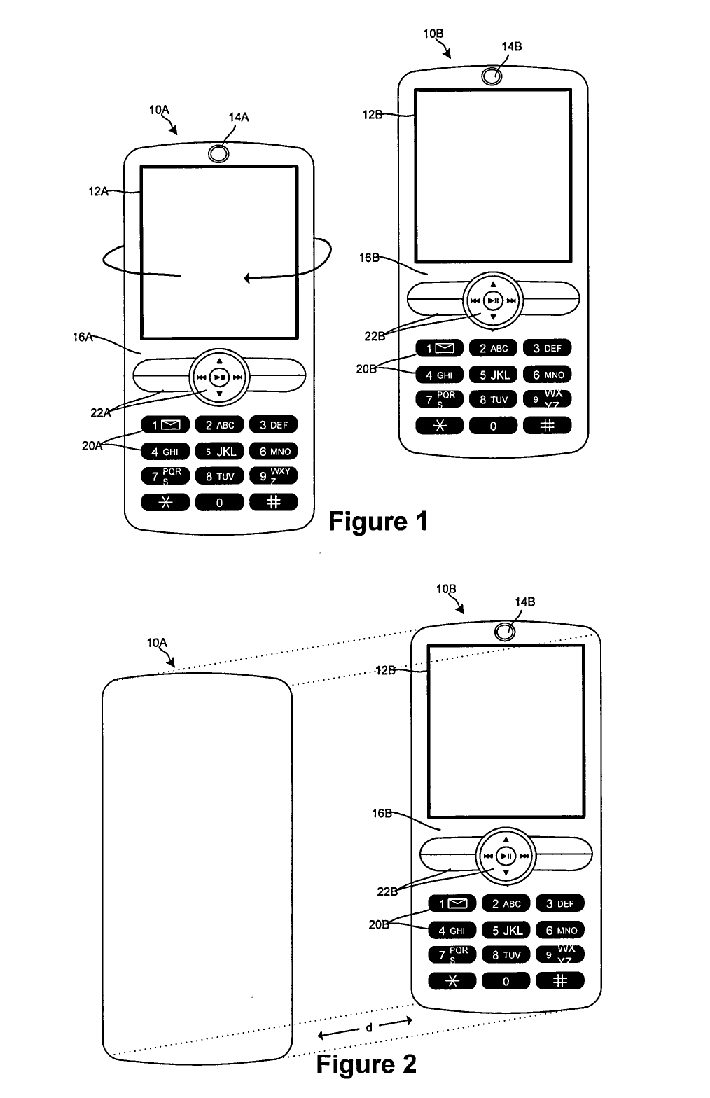

In general, a first wireless device having a first detector and a first electromagnetic source on a first surface is positioned within an operable distance (e.g., within communication range) from a second wireless device having a second detector and a second electromagnetic source on a second surface, as shown in FIG. 1. FIG. 2 illustrates the first surface 16A and the second surface 16B being oriented facing each other by rotating the first electronic equipment 10A as indicated by the arrow illustrated in FIG. 1. Electromagnetic radiation is transmitted in a predefined pattern (P) from the second electromagnetic source to the first detector, as illustrated in FIG. 3. Optionally, electromagnetic radiation may be transmitted from the first electromagnetic radiation source to the second detector 14B, as illustrated in FIG. 4. The detected pattern of electromagnetic radiation is processed at the first wireless device to establish a paired wireless communication link between the first wireless device and the second wireless device based at least in part on the first wireless device and the second wireless device facing each other for the predetermined time period and communication signals exchanged between the devices within the operable distance.

Referring to FIG. 1, two electronic equipment 10A and 10B are shown in accordance with aspects of the present invention. Each of the electronic equipment 10A and 10B include a source 12A and 12B for electromagnetic radiation and a detector 14A and 14B for detecting electromagnetic radiation. As shown in FIG. 1, the source and detector are located on an exterior surface 16A and 16B of the housing of the electronic equipment, respectively. As illustrated in FIG. 1, the surfaces 16A and 16B are referred to herein as the front (or face) of the electronic equipment. In addition, when the surfaces 16A and 16B are positioned or otherwise directed towards each other so as to allow detection of one or more signals and/or electromagnetic radiation emitted from one device to be detected by the other device, such orientation is referred to herein as “facing” each other. For example, in FIGS. 2-4, the electronic equipment 10A and 10B are illustrated facing each other.

Aspects of the present invention relate to positioning the electronic equipment 10A and 10B facing each other within an operable distance “d”, as illustrated in FIG. 2. The detector 14A from the first wireless device (e.g., electronic equipment 10A) detects electromagnetic radiation transmitted from the source 12B of the second wireless device (e.g., electronic equipment 10B), as shown in FIG. 3. The detected electromagnetic radiation is processed to establish a wireless communication link (e.g., GSM, CDMA, WCDMA, MBMS, WiFi, WiMax, DVB-H, ISDB-T, Bluetooth, infrared, etc.) between the first wireless device and the second wireless device based at least in part on the first wireless device and the second wireless device facing each other for the predetermined time period and communication signals exchanged between the devices within the operable distance.

Referring back to FIG. 1, the general functionality associated with electronic equipment 10A will now be discussed. One of ordinary skill in the art will readily appreciate that the electronic equipment 10B contains the same general functionality as electronic equipment 10A. For purposes of brevity, only the components and functionality of electronic equipment 10A will be discussed. However, unless otherwise stated, electronic equipment 10B includes similar components and/or functionality as electronic equipment 10A.

The electronic equipment 10A in the illustrated embodiments is a mobile telephone and will be referred to as the mobile telephone 10A. The mobile telephone 10A is shown as having a “brick” or “block” form factor housing 18, but it will be appreciated that other type housings, such as a clamshell housing or a slide-type housing, may be utilized.

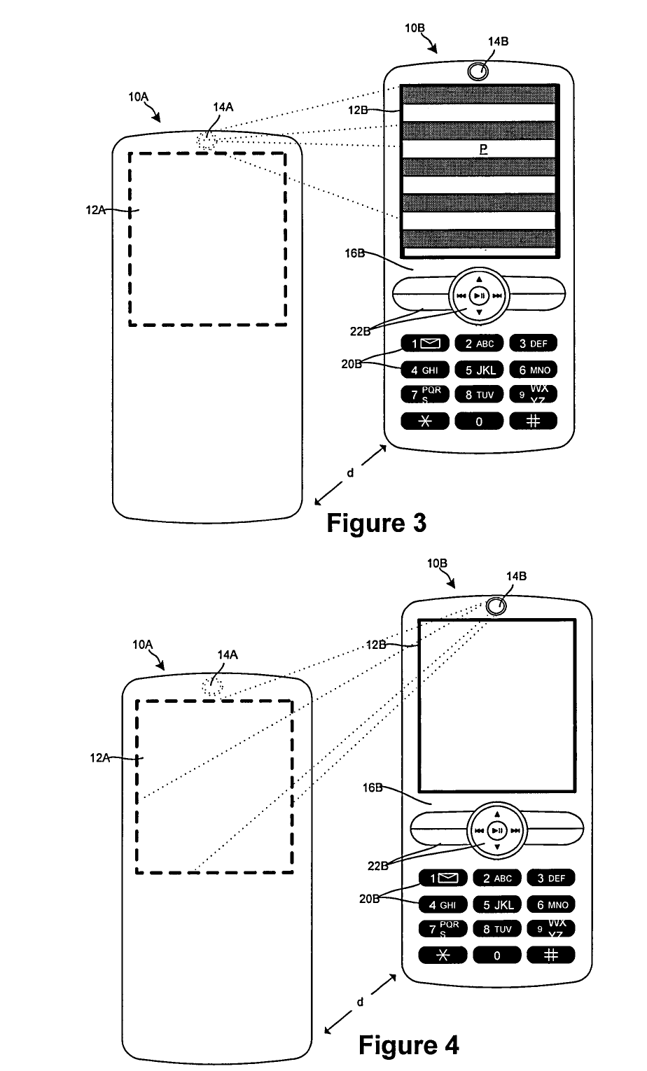

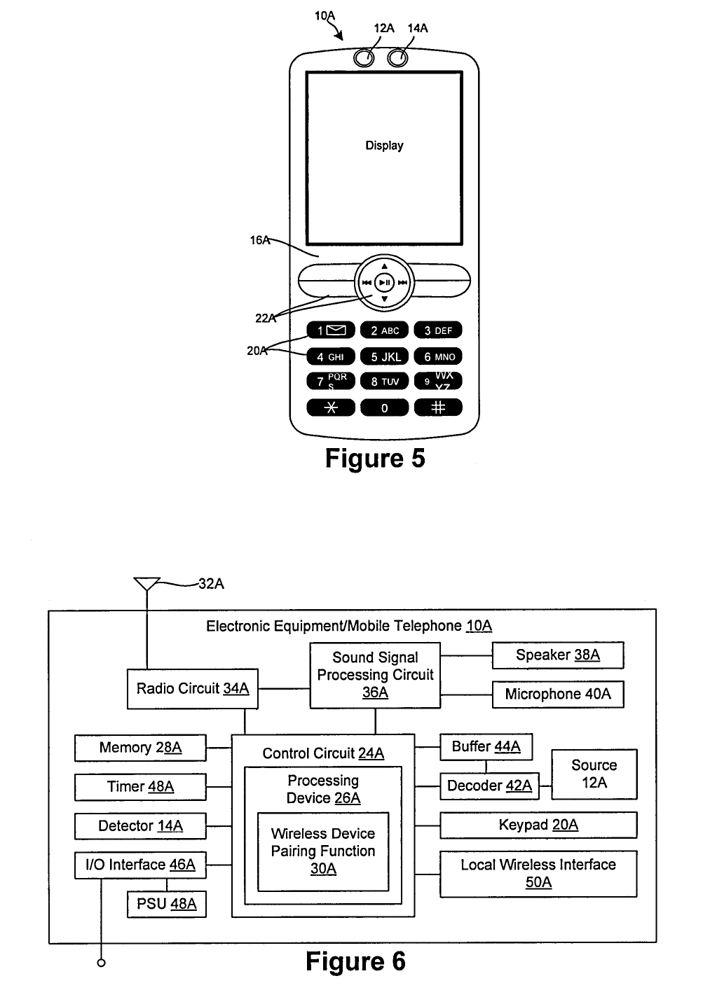

The mobile telephone 10A includes a source 12A of electromagnet radiation. For example, the source 12A may be a display (e.g., a liquid crystal display) (as shown in FIG. 1), a light emitting diode (LED) (as shown in FIG. 5), or other source of electromagnetic radiation, etc. The mobile telephone 10A also includes keypad 20A. The source 12A, when in the form of a display may present information to a user such as operating state, time, telephone numbers, contact information, various navigational menus, etc., which enable the user to utilize the various features of the mobile telephone 10A. The source 12A, when in the form of a display may also be used to visually display content received by the mobile telephone 10A and/or retrieved from a memory 28A (FIG. 6) of the mobile telephone 10A. In addition, an image may be displayed on the source 12A, such as a photograph taken by a camera of the mobile telephone 10A or a photo preview image when the source functions as an electronic viewfinder for the camera.

The mobile telephone 10A also includes a detector 14A (also referred herein as a sensor) coupled to the control circuit 24A. The detector 14A may be any desirable detector capable of detecting any type of physical property. For example, the detector 14A may be an optical sensor that is capable of detecting electromagnetic radiation, such as for example, a camera, a video telephony camera, a photodiode; photodetector, photocells, photodiodes, phototransistors, CCDs, and image sensors; infra-red sensors, a proximity sensor, which may be optical, for example, a combination of a photocell and LED or laser, a magnet; and/or a Hall effect device.

The keypad 20A may provide for a variety of user input operations. For example, the keypad 20A may include alphanumeric keys 20A for allowing entry of alphanumeric information such as telephone numbers, phone lists, contact information, notes, etc. In addition, the keypad 20A may include special function keys 22A such as a “call send” key for initiating or answering a call, and a “call end” key for ending or “hanging up” a call. Special function keys 22A may also include activation dedicated function keys for activating an pairing protocol to couple one mobile telephone (e.g., 10A) to communicate with another mobile telephone (e.g., 10B). Special function keys 22A may also include menu navigation keys, for example, for navigating through a menu displayed on the source 12A (when the source is a display) to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the source 12A, for example when the source 12A is a display.

The mobile telephone 10A includes conventional call circuitry that enables the mobile telephone 10A to establish a call and/or exchange signals with a called/calling device, typically another mobile telephone or landline telephone. However, the called/calling device need not be another telephone, but may be some other device such as an Internet web server, content providing server, etc. The call circuitry also may be responsible for transmitting text messages that are prepared by the user.

With reference to FIG. 6, additional components of the mobile telephone 10A will be described. For the sake of brevity, generally conventional features of the mobile telephone 10A will not be described in great detail herein. The mobile telephone 10A includes a primary control circuit 24A that is configured to carry out overall control of the functions and operations of the mobile telephone 10A. The control circuit 24A may include a processing device 26A, such as a CPU, microcontroller or microprocessor. The processing device 26A executes code stored in a memory (not shown) within the control circuit 24A and/or in a separate memory, such as memory 28A, in order to carry out operation of the mobile telephone 10A. The memory 28A may be, for example, one or more of a buffer, a flash memory, a hard drive, a removable media, a volatile memory, a non-volatile memory or other suitable device. In addition, the processing device 26A executes code in order to perform a wireless device pairing function 30A.

It will be apparent to a person having ordinary skill in the art of computer programming, and specifically in applications programming for mobile telephones or other electronic devices, how to program a mobile telephone 10A to operate and carry out the functions described herein. Accordingly, details as to the specific programming code have been left out for the sake of brevity. Also, while the wireless device paring function 30A is executed by the processing device 26A in accordance with the preferred embodiment of the invention, such functionality could also be carried out via dedicated hardware, firmware, software, or combinations thereof, without departing from the scope of the invention.

Continuing to refer to FIG. 6, the mobile telephone 10A includes an antenna 32A coupled to a radio circuit 34A. The radio circuit 34A includes a radio frequency transmitter and receiver for transmitting and receiving signals via the antenna 32A as is conventional. The radio circuit 34A may be configured to operate in a mobile communications system. The radio circuit 34A may be further configured to receive data and/or audiovisual content. For example, the receiver may be an IP datacast compatible receiver compatible with a hybrid network structure providing mobile communications and digital broadcast services, such as DVB-H mobile television and/or mobile radio. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10A further includes a sound signal processing circuit 36A for processing audio signals transmitted by/received from the radio circuit 34A. Coupled to the sound processing circuit 36A are a speaker 38A and a microphone 40A that enable a user to listen and speak via the mobile telephone 10A as is conventional. The radio circuit 34A and sound processing circuit 36A are each coupled to the control circuit 24A so as to carry out overall operation. Audio data may be passed from the control circuit 24A to the sound signal processing circuit 36A for playback to the user. The audio data may include, for example, audio data from an audio file stored by the memory 28A and retrieved by the control circuit 24A. The sound processing circuit 36A may include any appropriate buffers, decoders, amplifiers and so forth.

The mobile telephone 10A also includes the aforementioned source of electromagnetic radiation 12A (e.g. a display, light emitting diode, infrared output source, ultrasound output source, etc.) coupled to the control circuit 24A. The source 12A may be coupled to the control circuit 24A by a video decoder 42A that converts electromagnetic radiation into video data for a video signal used to drive the source 12A, for example when source 12A is a display. The video data may be generated by the control circuit 24A, retrieved from a video file and/or one or more predefined patterns that is stored in the memory 28A and/or associated with the wireless device paring function 30A, derived from an incoming video data stream received by the radio circuit 34A or obtained by any other suitable method. Prior to being fed to the decoder 42A, the video data may be buffered in a buffer 44A.

The mobile telephone 10A further includes one or more I/O interface(s) 46A. The I/O interface(s) 46A may be in the form of typical mobile telephone I/O interfaces and may include one or more electrical connectors. As is typical, the I/O interface(s) 46A may be used to couple the mobile telephone 10A to a battery charger to charge a battery of a power supply unit (PSU) 48A within the mobile telephone 10A. In addition, or in the alternative, the I/O interface(s) 46A may serve to connect the mobile telephone 10A to a wired personal hands-free adaptor (not shown), such as a headset (sometimes referred to as an earset) to audibly output sound signals output by the sound processing circuit 36A to the user. Further, the I/O interface(s) 46A may serve to connect the mobile telephone 10A to a personal computer or other device via a data cable. The mobile telephone 10A may receive operating power via the I/O interface(s) 46A when connected to a vehicle power adapter or an electricity outlet power adapter.

The mobile telephone 10 may also include a timer 48A for carrying out timing functions. Such functions may include timing the durations of calls, generating the content of time and date stamps, automatically acquiring images at predetermined and/or user defined time intervals. Such timing functions may also include, for example, determining how much time has expired while one mobile telephone (e.g., 10A) is facing another mobile telephone (e.g., 10B). The timing functions may be triggered by hardware and/or software.

As indicated, the mobile telephone 10A includes a detector 14A (e.g., an optical sensor) for acquiring electromagnetic radiation in the form of image data, LED signaling data or any other desirable form. The detector 14A, which may be any desirable detector capable of detecting any type of physical property, is coupled to the control circuit 24A. The detected data may be stored in the memory 28A and/or used by the control circuit 24A to determine an occurrence of an event and/or for control purposes associated with the mobile telephone 10.

The mobile telephone 10 includes a local wireless interface 50A, such as an infrared transceiver and/or an RF adaptor (e.g., a Bluetooth adapter), for establishing communication with an accessory, a hands-free adaptor (e.g., a headset that may audibly output sounds corresponding to audio data transferred from the mobile telephone 10A to the adapter), another mobile radio terminal (e.g., mobile telephone 10B), a computer or any another device capable of wireless communication.

The mobile telephone 10A may be configured to transmit, receive and process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth from the device in which it is connected. Processing such data may include storing the data in the memory 28A, executing applications to allow user interaction with data, displaying video and/or image content associated with the data, outputting audio sounds associated with the data and so forth.

The mobile telephone 10A may be configured to operate as part of a communications system. The system may include a communications network having a server (or servers) for managing calls placed by and destined to the mobile telephone 10A, transmitting data to the mobile telephone 10A and carrying out any other support functions. The server generally communicates with the mobile telephone 10A via a transmission medium. The transmission medium may be any appropriate device or assembly, including, for example, a communications tower, another mobile telephone, a wireless access point, a satellite, etc. Portions of the network may include wireless transmission pathways. The network may support the communications activity of multiple mobile telephones (e.g., mobile telephones 10A and 10B).

Prior to mobile telephones 10A and 10B establishing a wireless communication link for exchanging information and/or services, the devices may be paired to each other and/or capable of communicating automatically with each other (e.g., by automatically dialing a telephone number of another device without the user dialing the number). The following description will discuss establishing a wireless communication link with Bluetooth compatible wireless technology. However, other wireless communication links may be used for exchanging information and/or services. Such communication links include, for example, GSM, CDMA, WCDMA, MBMS, WiFi, WiMax, DVB-H, ISDB-T, Bluetooth, infrared, etc.

Bluetooth technology provides a manner in which many wireless devices may communicate with one another, without connectors, wires or cables. A wireless interface commonly used in headsets and mobile telephones is referred to as “Bluetooth” technology. Bluetooth refers to a technical specification designed to standardize wireless transmission between a wide variety of electronic devices, such as personal computers, mobile telephones, cordless telephones, headsets, printers, personal digital assistants (“PDAs”), etc. Bluetooth acts as a “virtual cable”, whereby one electronic device can easily communicate with another electronic device. Bluetooth technology uses the free and globally available unlicensed 2.4 GHz radio band, for low-power use, allowing two Bluetooth devices within a range of up to 10 to 100 meters (also referred to herein as “operable distance”) to share data with throughput up to 2.1 Mbps. Each Bluetooth device can simultaneously communicate with many other devices.

Before two Bluetooth enabled devices (e.g., mobile telephones 10A and 10B) may communicate, the devices are generally paired. Bluetooth pairing occurs when the two Bluetooth enabled devices become a trusted pair. Conventionally, to become a trusted pair, two Bluetooth devices would first complete a specific discovery and authentication process. When a first Bluetooth device recognizes a second Bluetooth device and complete a specific discovery and authentication process, each device can automatically accept communication between them.

Device discovery is the procedure a Bluetooth wireless device uses to locate nearby Bluetooth wireless devices with which it wishes to communicate. Exchanging the Bluetooth addresses of the discoverable devices, their friendly names and other relevant information via establishing a short term connection with each device in the vicinity can be a time consuming procedure. The procedure can involve having one Bluetooth wireless device transmitting an inquiry request to other Bluetooth wireless devices scanning for inquiry requests. A device that transmits the inquiry request (a potential master) is said to be discovering devices while the device that is scanning for inquiry requests is said to be discoverable. The discoverable device (a potential slave) performs a process called inquiry scanning, during which it looks for an inquiry request. Once a discoverable device receives an inquiry request, it responds with Frequency Hopping Synchronization (FHS) packets. These packets include, among other fields, the discoverable device's 6-byte Bluetooth device address and 3-byte Class of Device (COD). The list of the discovered devices is then presented to the user. The user may select the desired device to be paired with.

During the device discovery procedure it is possible to obtain further information from discoverable devices such as the Bluetooth devices friendly names. To do this the discovering device sends a page request to the discovered device's Bluetooth device address(es), at which point the discovering device initiates a short term connection with the discoverable device(s) and becomes a master. When a discoverable device responds to a page request, it becomes a slave. At this point, the devices are not paired, but the master can send a request for the slave's friendly name. For example, the friendly name may look like “Bluetooth Headset”.

Typically instead of the hexadecimal Bluetooth addresses the list of devices' friendly names is presented to the user at the end of the discovery procedure. At this moment the user can select the Bluetooth wireless device he or she desires to start the communication with. After the user makes a selection, the discovering device can initiate a connection with the newly discovered device using the discovered device's Bluetooth device address. Without device discovery a Bluetooth wireless device would not know the Bluetooth device address of other Bluetooth devices which is required information for establishing a connection between the devices.

The master device is a device that initiates a connection. The device that accepts a connection becomes the slave device. For example, when a mobile telephone initiates the discovery and pairing procedure it behaves as a master and the headset becomes a slave. Next time when the user powers the headset up the headset actively looks for the previously paired mobile telephone, initiates connection to it and becomes a master. Upon accepting connection, the mobile telephone becomes a slave. Furthermore, during the ongoing connection the master/slave roles can be switched if required.

During the discovery process, the devices are generally in discovery mode. There may be a toggle, switch or other setting mechanism for making the devices either discovering or discoverable ones. Conventionally, when the telephone and the headset are delivered to the user as a bundled solution, the devices are not pre-paired. The initial “out-of-the-box” pairing Bluetooth enabled telephones and headsets is required to operate the set, however, the conventional pairing process is complicated and causes certain difficulties and confusion among the users.

In practice, when a user receives a device such as a headset and a device such as a cellular telephone, the user is required to prepare both devices for discovery and the subsequent authentication process. Unfortunately, there are a substantial number of prompts generated by both devices so that the process of pairing can be difficult for most consumers. Moreover, the communication between the devices being in discoverable mode could be easily accessed by the hackers. Thus, it may be beneficial if the number of steps during the discovery process were reduced or eliminated.

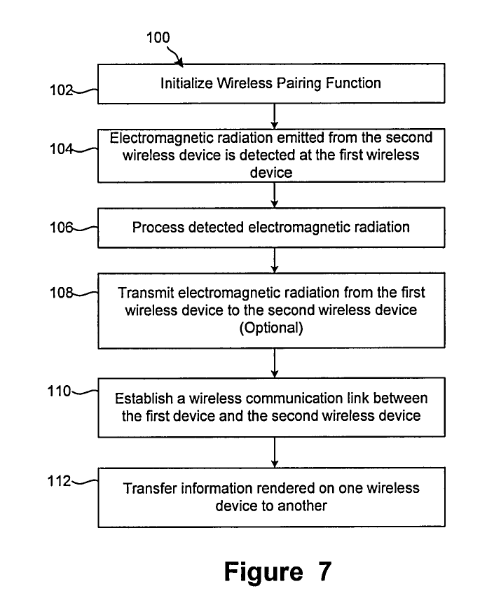

With additional reference to FIG. 7, illustrated is a flow chart of logical blocks that make up certain features the wireless device pairing function 22. The flow chart may be thought of as depicting steps of a method. Although FIG. 7 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

An exemplary method 100 for pairing wireless devices is illustrated in FIG. 7. At block 102, the method 100 may be initiated by one or more users positioning a first wireless device (e.g., mobile telephone 10A) within an operable distance “d” (shown in FIG. 2) from a second wireless device (e.g., mobile telephone 10B), wherein the devices are oriented facing each other for a predetermined time period.

In one embodiment, the first wireless device (e.g., mobile telephone 10A) includes a first detector (e.g., detector 14A) and a first electromagnetic source 12A located on an exterior housing of the first wireless device. Preferably, the detector 14A and source 12A are positioned on a first surface 16A or on multiple surfaces of the housing that are oriented in the same general direction (e.g., on the front of the device, on the back of the device, etc.). Likewise, the second wireless device (e.g., mobile telephone 10B) also includes a second detector (e.g., detector 14B) and a second electromagnetic source (e.g., second electromagnetic source 12B) located on an exterior housing surface of the second wireless device. Again, the detector 14B and source 12B may be positioned on a second housing surface 16B or on multiple surfaces of the housing that are oriented in the same general direction (e.g., on the front of the device, on the back of the device, etc.). As one of ordinary skill in the art will appreciate, the housing surface in which the detector and the sensor are located may be comprised a single surface (e.g., one-piece construction) or on multiple surfaces (e.g., multi-piece construction).

The first surface 16A and the second surface 16B are oriented facing each other for a predetermined time period. As discussed above, when the surfaces 16A and 16B are positioned to point towards each other, the detectors from each device can detect one or more signals (e.g., electromagnetic radiation, etc.) emitted from the other device. Such orientation is referred to herein as “facing” each other. As used herein, “facing” orientation includes orientations of the devices that are not parallel to each other, e.g., offset, angled, and tilted, with respect to each other. So long as the detectors of the devices are able to detect signals emitted from the other device, such orientation is considered to be “facing” each other.

A predefined time period may be any desirable period of time. The predefined time is generally long enough to ensure that the two wireless devices do not start the pairing process accidentally. For example, a suitable period of time for one device to face another device to show a manifestation of user intent to initiate the pairing process may range from seconds (e.g., 3 seconds) to several seconds (e.g., 30 seconds or more). Preferably, the predetermined time is approximately 10 to 15 seconds. One of ordinary skill in the art will appreciate that the predefined time period is selected to be long enough to minimize accidentally pairing a device with another device by inadvertently positioning the devices together and short enough to minimize the time necessary for users to manifest their intent for devices to pair.

In another embodiment, the method 100 may be initiated by user action, for example, a user de-pressing a key on the keypad. The method proceeds to block 102 for processing as discussed above.

At block 104, electromagnetic radiation emitted from second electromagnetic radiation source (e.g., source 12B) in a predefined pattern (P) (FIG. 3) is detected at the first detector (e.g., detector 14A). As one of ordinary skill in the art will readily appreciate, the step of detecting may vary based on the type of detector. For example, if the detector 14A is a camera and/or video telephony camera, images (or videos) of the mobile telephone 10B will be acquired periodically.

One of ordinary skill in the art will readily appreciate that the type of pattern will depend on the type of electromagnetic source (e.g. sources 12A and 12B). For example, if the electromagnetic radiation source is a display, the type of pattern may be displayed, e.g., in a bar pattern, as shown in FIG. 3. Suitable bar patterns may be color bar patterns, pluge patterns, grayscale patterns, staircase patterns, stairstep pattern, crosshatch pattern, geometrical patterns, white window patterns, etc. The patterns may be horizontal, vertical or a combination of horizontal and vertical elements. When the electromagnetic radiation source is a display, it is desirable that the predefined pattern is not perceptible to the user. Accordingly, the pattern may be displayed for a sufficient time to be detected by a detector (e.g., detector 14A, 14B). In cases where the electromagnetic radiation source 12A, 12B is a LED (or other binary device), the patterns may be a sequence of on-off pulses of electromagnetic radiation periodically emitted by the source. The pulses may vary in frequency, duration of the pulses, number of pulses, and any other physical characteristic associated with the pulse(s). Furthermore, there may be a variety of pulse patterns and/or display patterns that may be used for identification of the wireless device, identification of services available, etc. In one embodiment, display pattern may be continuously flashed (or repeated), in order for the device instantly may share, send or stream any content displayed on device screen with another device.

In one embodiment, the predefined pattern of electromagnetic radiation is detected at the second detector prior to transmitting the predefined pattern to the first wireless device.

At block 106, the detected electromagnetic radiation is processed to establish a wireless communication link between the first wireless device and the second wireless device based at least in part on the first wireless device and the second wireless device facing each other for the predetermined time period within the operable distance. In one embodiment, the step of processing the detected electromagnetic radiation to establish a wireless communication link between the first wireless device and the second wireless device includes determining whether the detected electromagnetic radiation is valid by comparing the detected electromagnetic radiation to one or more authorized responses stored in a memory of the first wireless device and/or second wireless device. For example, the detected signals are compared to previously stored values that constitute authorized signals to initiate the pairing process.

The detectors 14A, 14B may periodically acquire images and/or video and store them in memory. The period of time between acquiring images may be any desirable period of time. The period may be selected from predefined periods of time and/or periods of time set by the user. The images may be temporarily stored in memory until a predefined event occurs. The processing step generally involves processing image data to determine an object and/or an occurrence of a predefined event. The images may be processed in any manner to determine an object and/or the occurrence of the predefined event. For example, two or more images may be compared to each other to determine if a predefined object is being detected. To assist the user in determining that a predefined object has been detected and/or an event has occurred and detected by the detector, an audible (e.g., a beep) or viewable (e.g., flash or a blinking light emitting diode) signal may be directed to the user. In this way, the user is not kept guessing as to whether a certain event has been detected.

Optionally, at block 106, the method 100 may include further transmitting electromagnetic radiation in the predefined pattern from the first electromagnetic source for receipt by the second detector in response to detecting the electromagnetic radiation transmitted by the second electromagnetic radiation source. For example, electromagnetic radiation source 12A, 12B display the predefined pattern on a display associated with the first wireless device. The transmitted pattern may be identical to the received pattern or may be distinct depending on the information and/or purpose of transmission. Such information may include device identification information, network addresses, available services, telephone numbers, mode of communication, etc.

At block 110, a wireless communication link is established between the first wireless device and the second wireless device. For example, the Bluetooth address of the wireless devices may be exchanged and stored in memory, as is conventional. For other communication modes, other suitable may be exchanged, e.g., telephone number, network address, device identification, etc. In one embodiment, the wireless communication link is preferably a paired communication link. In another embodiment, the wireless communication link is a Bluetooth paired communication link. In another embodiment, the wireless communication link is a Bluetooth trusted pair communication link. A trusted pair communication link occurs when one device recognizes another device and each device automatically accepts communication, bypassing the discovery and authentication process that normally happen during Bluetooth interactions.

One of ordinary skill will readily appreciate that once a wireless communication link is established between the first wireless device and the second wireless device, information, content and/or services may be shared or otherwise exchanged between the devices.

For example, at block 112, once the first and second devices have been paired, if a user desires to share information (e.g. a file, multimedia content, etc.) with a paired device this may be done automatically after the initial paring. For example, if a user is viewing a picture on a display and holds the mobile telephone toward a paired mobile telephone, the picture is transmitted through a wireless communication link (e.g., GSM, CDMA, WCDMA, MBMS, WiFi, WiMax, DVB-H, ISDB-T, Bluetooth, infrared, etc.). Since the predefined pattern (of blocks 104 and 106) may be continuously flashed or embedded (without flashing) in the picture (e.g., similar to encryption in images), the picture file is transmitted. One of ordinary skill in the art will readily appreciate that similar functionality may be used to transmit part of the user interface (e.g., information presented on a display) and/or multimedia content being rendered on the wireless devices

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. A method for pairing wireless devices, the method comprising:
positioning a first wireless device having a first detector and a first electromagnetic source on a first surface within an operable distance from a second wireless device having a second detector and a second electromagnetic source on a second surface, wherein the first surface and the second surface are oriented facing each other for a predetermined time period;
detecting electromagnetic radiation in a predefined pattern at the first detector, wherein the electromagnetic radiation was transmitted from the second electromagnetic radiation source;
processing the detected electromagnetic radiation to establish a wireless communication link between the first wireless device and the second wireless device based at least in part on the first wireless device and the second wireless device facing each other for the predetermined time period within the operable distance; and
establishing the wireless communication link between the first wireless device and the second wireless device.

2. The method of claim 1 further including transmitting electromagnetic radiation in the predefined pattern from the first electromagnetic source for receipt by the second detector in response to detecting the electromagnetic radiation transmitted by the second electromagnetic radiation source.

3. The method of claim 2, wherein the step of transmitting electromagnetic radiation in the predefined pattern from the first electromagnetic source to the second detector includes displaying the predefined pattern on a display associated with the first wireless device.

4. The method of claim 3, wherein the predefined pattern is periodically displayed on the display for a duration that is not perceptible to an associated user of the first wireless device and/or the second wireless device.

5. The method of claim 4, wherein the first detector is an optical sensor for detecting the response transmitted from the second wireless device.

6. The method of claim 6, wherein the optical sensor is a video telephony camera.

7. The method of claim 1, wherein the first electromagnetic source is a light emitting diode that transmits electromagnetic radiation in the predefined pattern.

8. The method of claim 1, wherein the detected electromagnetic radiation is generated by displaying the predefined pattern on a display associated with the second wireless device.

9. The method of claim 1, wherein the step of processing the detected electromagnetic radiation to establish a wireless communication link between the first wireless device and the second wireless device includes determining whether the detected electromagnetic radiation is valid by comparing the detected electromagnetic radiation to one or more authorized responses stored in a memory of the first wireless device.

10. The method of claim 1 further including detecting the predefined pattern of electromagnetic radiation at the second detector prior to transmitting the predefined pattern to the first wireless device.

11. The method of claim 1, wherein the communication link is a mobile telephony communication link.

12. The method of claim 1, wherein the communication link is a Bluetooth compatible communication link.

13. The method of claim 1 further including automatically transferring a file rendered on the first wireless device to the second wireless device upon establishing the wireless communication link.

14. A wireless communication device comprising:
a source of electromagnetic radiation and a sensor located on a surface of a housing of a wireless communication device; and
a processor coupled to the source of electromagnetic radiation and the sensor, wherein when the sensor detects an associated wireless device is facing the wireless communication device and is positioned within an operable distance for a predefined period of time, the processor is configured to:
detect electromagnetic radiation at the sensor, wherein the source of the electromagnetic radiation is an associated wireless device and output electromagnetic radiation in a predefined pattern; and
process the detected electromagnetic radiation to establish a wireless communication link between the device and the associated wireless device based at least in part on the device and the associated wireless device facing each other for the predetermined period of time within the operable distance.

15. The device of claim 14, wherein the sensor is an optical sensor.

16. The device of claim 14, wherein the source of electromagnetic radiation is a display.

17. The device of claim 14, wherein the source of electromagnetic radiation is a light emitting diode.

18. The device of claim 14, wherein the communication link is a Bluetooth compatible communication link.

19. The device of claim 14, wherein the communication link is cellular telephony communication link.

20. A wireless communication device comprising:
a source of electromagnetic radiation and a sensor located on a surface of a housing of a wireless communication device; and
a processor coupled to the source of electromagnetic radiation and the sensor, wherein when the sensor detects an associated wireless device is facing the wireless communication device and is positioned within an operable distance for a predefined period of time, the processor is configured to:
transmit electromagnetic radiation in a predefined pattern from a source to an associated wireless device having a detector for detecting the predefined pattern of electromagnetic radiation; and
establish a wireless communication link between the wireless device and the associated based on the wireless communication device facing the associated wireless device for the predefined period and for the predefined period of time.
